(19) United States
(12) Patent Application Publication
(10) Pub. No.: US 2018/0352877 A1
(43) Pub. Date: Dec. 13, 2018

(54) HEATABLE WEAR DEVICE

(71) Applicant: CARMMING INTERNATIONAL, New Taipei City (TW)

(72) Inventor: Kuo-Hua CHUNG, New Taipei City (TW)

(21) Appl. No.: 15/616,923

(22) Filed: Jun. 8, 2017

(51) Int. Cl. A41D 13/005; A41D 1/00; A41D 19/015; A41B 11/00; A41D 1/04; A41D 23/00; H05B 1/02; H05B 3/34; H05B 3/12; H01M 2/02; H01M 10/42

(52) U.S. Cl. CPC A41D 13/0051; H01M 2220/30; A41D 19/01594; A41D 19/01535; A41B 11/00; A41D 1/04; A41D 23/00; H05B 1/0272; H05B 3/347; H05B 3/12; H01M 2/0275; H01M 10/425; H05B 2203/015; H05B 2203/036; A41D 1/002

(57) ABSTRACT

A heatable wear device includes a wear body, at least one heating module, and a circuit board. The heating module is installed inside the wear body and includes an explosion-proof battery, a heating layer, and a covering layer with a high specific heat. The heating layer is electrically connected to the explosion-proof battery and disposed corresponding to the explosion-proof battery. The covering layer with a high specific heat is clamped between the explosion-proof battery and the heating layer. The covering layer with a high specific heat includes a first surface and a second surface opposite to the first surface. The first surface is attached to the explosion-proof battery and the second surface is attached to the heating layer. The circuit board is installed inside the wear body and electrically connected to the explosion-proof battery.

### BACKGROUND OF THE INVENTION

### Field of the Invention

The present invention relates to a heating structure used with a wear device, such as a glove, a sock, and a scarf and in particular to a heatable wear device.

### Description of Prior Art

To withstand the cold climate like cold stream or snow, there are wear devices, such as gloves, socks, scarfs, hoods, respirators, and earmuffs equipped with the heating structure available in the market, which provide the heat sources to keep the user warm. The heating structure is usually formed by the lithium-ion battery or solid state battery and the heating plate connected electrically to each other. The lithium-ion battery or solid state battery provides power for the heating plate to generate heat.

However, the lithium-ion battery or solid state battery cannot be disposed near the heating plate during the assembly process because of the issues of manufacturing and material of the lithium-ion battery or solid state battery. Therefore, the lithium-ion battery or solid state battery has to be kept a safe distance away or isolated from the heating plate such that the lithium-ion battery or solid state battery can be protected properly. Consequently, the above-mentioned disposition results in the problems of excessive assembled space, complicated assembly steps, and diffused heat sources.

In view of this, the inventor pays special attention to research with the application of related theory and tries to improve and overcome the above disadvantages regarding the above related art, which becomes the improvement target of the inventor.

### SUMMARY OF THE INVENTION

The present invention provides a heatable wear device which uses a closer assembly between the explosion-proof battery and the heating layer, the covering layer with a high specific heat of the explosion-proof battery as a heat reservoir to absorb the heat radiated from the filament. As a result, the heatable wear device has the advantages of a compact assembly space, simpler assembly steps, reduced power consumption, energy saving, and a concentrated heat source.

In the current embodiment, the present invention provides a heatable wear device which comprises a wear body, at least one heating module, and a circuit board. The at least one heating module is installed inside the wear body. The at least one heating module comprises an explosion-proof battery, a heating layer electrically connected to the explosion-proof battery and disposed corresponding to the explosion-proof battery, and a covering layer with a high specific heat. The covering layer with a high specific heat is clamped between the explosion-proof battery and the heating layer and comprises a first surface and a second surface opposite to the first surface. The first surface is attached to the explosion-proof battery and the second surface is attached to the heating layer. The circuit board is installed inside the wear body and electrically connected to the explosion-proof battery.

Based on the above description, the radiation heat stored in the covering layer with a high specific heat can maintain the existing temperature to increase the operation time of the explosion-proof battery under the same capacity and to reduce the volume of energy storage such that the heatable wear device of the present invention can achieve the effects of reduced power consumption and energy saving.

### BRIEF DESCRIPTION OF DRAWING

FIG. 1 shows an operational view of the heatable wear device according to the first embodiment of the present invention;

FIG. 2 shows a cross-sectional schematic view the heating module according to the first embodiment of the present invention;

FIG. 3 shows an operational view of the heatable wear device according to the second embodiment of the present invention;

FIG. 4 shows an operational view of the heatable wear device according to the third embodiment of the present invention;

FIG. 5 shows an operational view of the heating module according to the second embodiment of the present invention;

FIG. 6 shows an operational view of the heating module according to the third embodiment of the present invention; and

FIG. 7 shows an operational view of the heatable wear device according to the fourth embodiment of the present invention.

### DETAILED DESCRIPTION OF THE INVENTION

The detailed description and technical details of the present invention will be explained below with reference to accompanying drawings. However, the accompanying figures are only for reference and explanation, but not to limit the scope of the present invention.

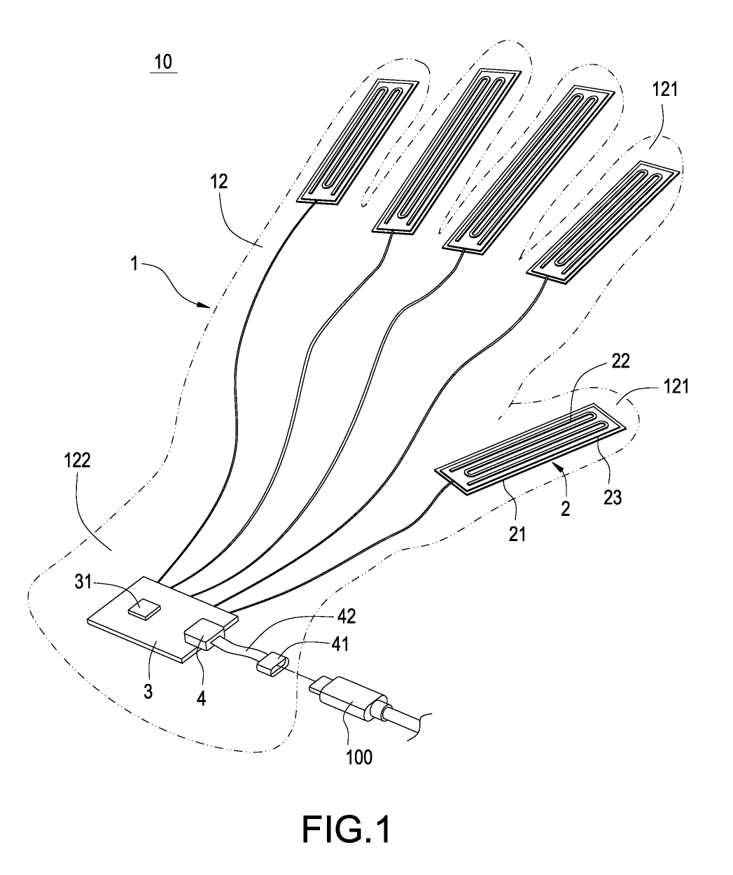

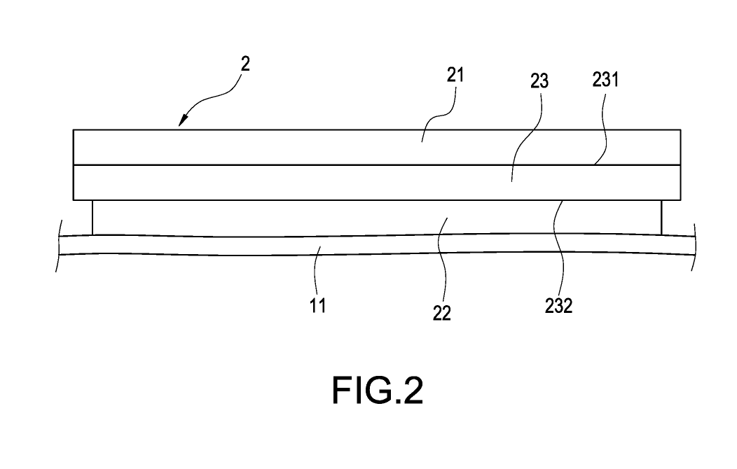

Please refer to FIGS. 1 and 2, which show the heatable wear device according to the first embodiment of the present invention. The heatable wear device 10 mainly comprises a wear body 1, at least one heating module 2, and a circuit board 3.

The wear body 1 may be a glove, a sock, a vest, or a scarf; that is, an article worn on a person. The details are given below. The wear body 1 has a lining 11. In the current embodiment, the wear body 1 is a glove 12 which comprises five finger portions 121 and a wrist portion 122. The lining 11 is formed on the inner surfaces of the respective finger portions 121.

In the current embodiment, the number of the heating modules 2 is five, but not limited to this. The five heating modules 2 are installed inside the wear body 1. In particular, each of the five heating modules 2 is installed inside the respective finger portions 121.

Each heating module 2 comprises an explosion-proof battery 21, a heating layer 22, and a covering layer 23 with a high specific heat. The heating layer 22 is electrically connected to the explosion-proof battery 21 and is disposed corresponding to the explosion-proof battery 21 and is attached to the lining 11. The covering layer 23 with a high specific heat is clamped between the explosion-proof battery 21 and the heating layer 22. The covering layer 23 with the high specific comprises a first surface 231 and a second surface 232 opposite to the first surface 231. The first surface 231 is attached to the explosion-proof battery 21 and the second surface 232 is attached to the heating layer 22.

Besides, the explosion-proof battery 21 is a Solid State Battery (SSB) in which SSB, the flexible printed circuit, is used as the battery substrate and the packaging material, together with the SSB as the chemical system. In this way, the SSB has an extreme thickness ranging from 0.32 mm to 0.36 mm and can be bent with a radius of curvature ranging from 15 mm to 17 mm. When an SSB is bent, it remains the same electric properties as a flat (unbent) SSB and does not form wrinkles. Also, the SSB still has high safety even when it suffers the physical impact of bending, hammering, or cutting, undergoes the harsh temperature test, such as the oven test at 200° C. for 10 minutes, the hot plate test at 250° C., or the high-temperature test of the flame gun at 700° C-1000° C., or other destructive testing of electrical properties. Consequently, the accident of fire, explosion, burning, and leakage can be avoided.

Moreover, the heating layer 22 is woven from meal wires made of, not limited to, iron, steel, or copper, or formed by the polyimide film heating pad or by the PTC (positive temperature coefficient) ceramic heating element. The covering layer 23 with the high specific heat is made of ceramic yarn or nylon yarn. The specific heat of the ceramic yarn is about 840 J/(Kg·K) and the specific heat of the nylon yarn is about 1700 J/(Kg·K) such that when the ceramic yarn and the nylon yarn are heated to a high temperature, they will emit radiation heat.

The circuit board 3 is installed inside the wear body 1 and is electrically connected to the explosion-proof battery 21. The controller 31 is installed on the circuit board 3; the controller 31 controls electrical conduction and electrical insulation between the explosion-proof battery 21 and the heating layer 22 through the circuit board 3. In the current embodiment, the circuit board 3 is installed inside the wrist portion 122.

The heatable wear device 10 of the present invention further comprises a USB connector 4 which is installed on the circuit board 3; the USB connector 4 has a USB female connector 41 and an extension cord 42. A terminal end of the extension cord 42 is connected to the USB female connector 41. The USB connector 4 is connected to an external charging connector 100 such that the external power supply can charge the explosion-proof battery 21.

The assembly of the heatable wear device 10 of the present invention is described below. The heating module 2 is installed inside the wear body 1. The heating layer 22 is electrically connected to the explosion-proof battery 21 and is disposed corresponding to the explosion-proof battery 21. The covering layer 23 with a high specific heat is clamped between the explosion-proof battery 21 and the heating layer 22. The covering layer 23 with the high specific comprises the first surface 23 land the second surface 232 opposite to the first surface 231. The first surface 231 is attached to the explosion-proof battery 21 and the second surface 232 is attached to the heating layer 22. The circuit board 3 is installed inside the wear body 1 and is electrically connected to the explosion-proof battery 21.

The operation of the heatable wear device 10 of the present invention used the following features. The explosion-proof battery 21 can be assembled closer to the heat layer 22; the covering layer 23 with a high specific heat of the explosion-proof battery 21 can be used as a heat reservoir to absorb the heat radiated from the filament. Therefore, the heatable wear device 10 has the advantages of a compact assembly space, simpler assembly steps, reduced power consumption, energy saving, and concentrated heat sources.

In addition, as soon as the circuit is actuated, the explosion-proof battery 21 conducts electricity to the metal heating layer 22 such that the heating layer 22 heats the lining 11 directly and heats the covering layer 23 with a high specific heat at the same time.

Then, when the circuit has been actuated for a while, the covering layer 23 with a high specific heat is heated to a high temperature and emits the radiation heat which heats the lining 11 again. As a result, the temperature of the lining 11 increases further.

Finally, when the temperature of the lining 11 increases again, the controller 31 controls the electrical insulation between the explosion-proof battery 21 and the heating layer 22 through the circuit board 3 to stop the heating of the heating layer 22. At this moment, the radiation heat stored in the covering layer 23 with a high specific heat is used to maintain the existing temperature to increase the operation time of the explosion-proof battery 21 under the same capacity and to reduce the volume of energy storage such that the heatable wear device 10 of the present invention can achieve the effects of reduced power consumption and energy saving.

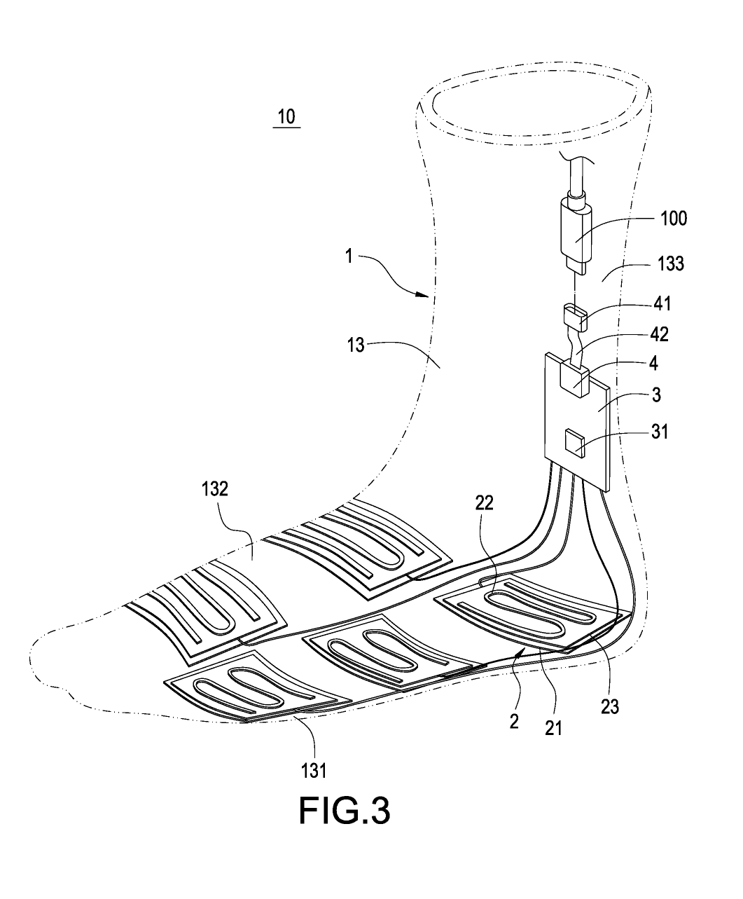

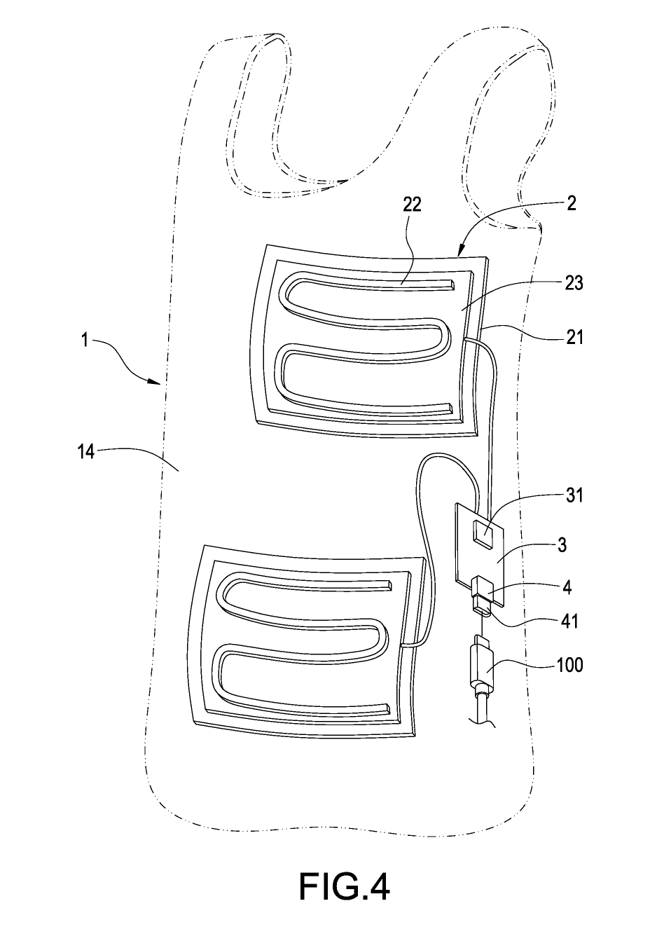

Please refer to FIGS. 3 and 4, which are the operational views of the heatable wear device 10 according to the second and the third embodiments of the present invention, respectively. The embodiments in FIGS. 3 and 4 are roughly similar to those in FIGS. 1 and 2. The differences between the embodiments in FIGS. 3 and 4 and in FIGS. 1 and 2 are that the wear body 1 may be a sock 13 or a vest 14, but not limited to these. The wear body 1 may be an article worn on a person, for example, a glove or a scarf.

The detailed description is given below. As shown in FIG. 3, the wear body 1 is a sock 13 which comprises a sole portion 131, an instep portion 132, and an ankle portion 133. The at least one heating module 2 is plural in number. Some of the heating modules 2 are installed inside the sole portion 131 and the others are installed inside the instep portion 132. The circuit board 3 is installed inside the ankle portion 133; the lining 11 is formed on the inner surfaces of the sole portion 131 and the instep portion 132.

As shown in FIG. 4, the wear body 1 is a vest 14. The heating modules 2 and the circuit board 3 are installed inside the vest 4; the lining 11 is formed on the inner surface of the vest 14. Besides, as shown in FIG. 4, the USB connector 4 in the current embodiment has only one USB female connector 41. However, as shown in FIGS. 1 and 2, the USB connector 4 further comprises an extension cord 42; the terminal end of the extension cord 42 is connected to the USB female connector 41. The extension cord 42 and the USB connector 4 both have the function of auxiliary charging, but the former provides greater convenience of power charging.

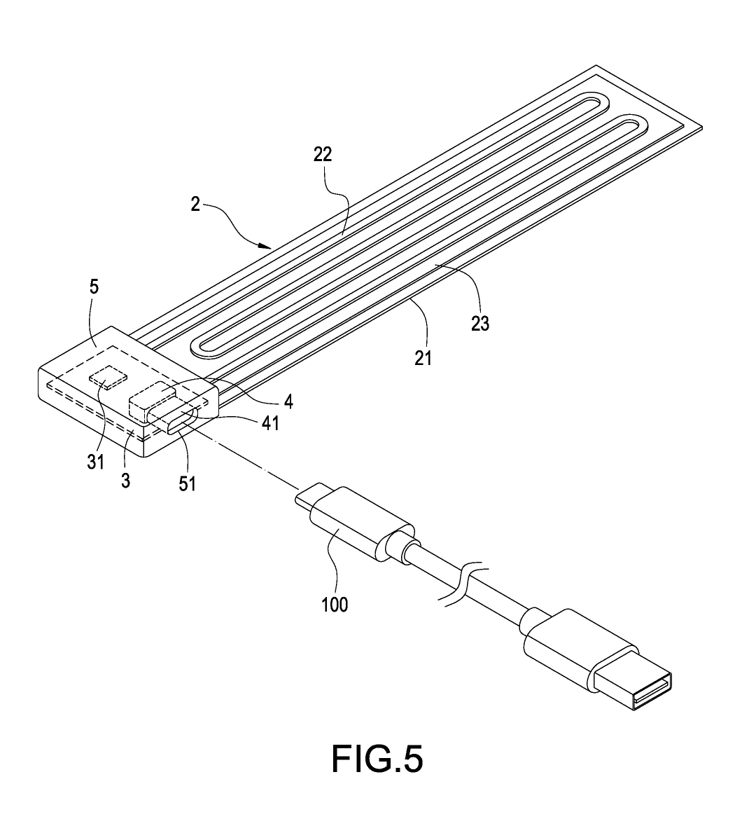

Please refer to FIGS. 5-7, which are the operational views of the heating module according to the second and the third embodiments of the present invention, and the operational view of the heatable wear device 10 according to the fourth embodiment of the present invention. The embodiments in FIGS. 5-7 are roughly similar to those in FIGS. 1 and 2. The differences between the embodiments in FIGS. 5-7 and in FIGS. 1 and 2 are that the heatable wear device 10 further comprises a fixed case 5.

The further description is given below. As shown in FIGS. 5-7, the at least one heating module 2 is single in number. The heating module 2 is attached to one side of the fixed case 5. The circuit board 3 is received inside the fixed case 5 which is provided with an opening 51 exposing the USB female connector 41. In this way, the fixed case 5 is used to protect the circuit board 3 and the USB connector 4.

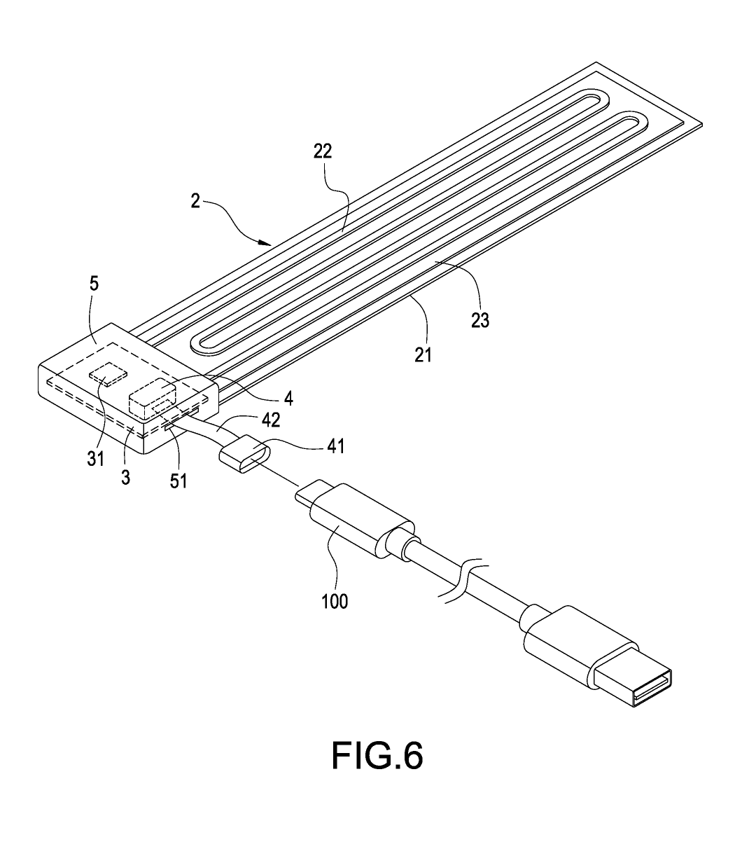

Besides, as shown in FIG. 5, the USB connector 4 in the current embodiment has only one USB female connector 41. However, as shown in FIG. 6, the USB connector 4 further comprises an extension cord 42; the terminal end of the extension cord 42 is connected to the USB female connector 41. The extension cord 42 and the USB connector 4 both have the function of auxiliary charging, but the former provides greater convenience of power charging.

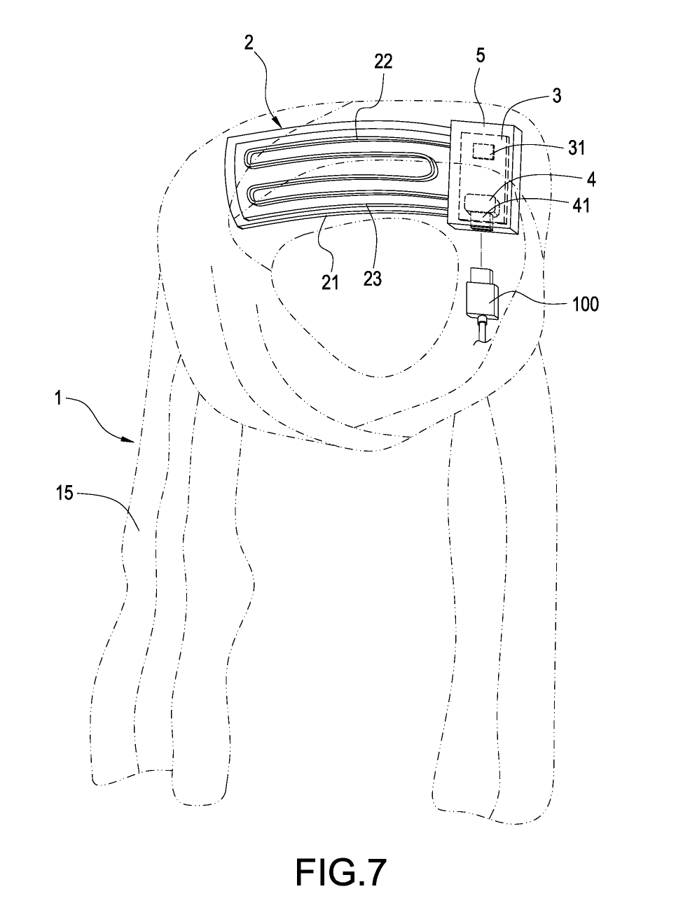

Moreover, as shown in FIG. 7, the wear body 1 in the current embodiment is a scarf 15. The at least one heating module 2, the circuit board 3, and the fixed case 5 are installed inside the scarf 15. The lining 11 is formed on the inner surface of the scarf 15. The wear body 1, not limited to the scarf 15, may be an article worn on a person like a glove.

In summary, the heatable wear device of the present invention has never been anticipated by similar products in the market and used in public. Also, it is indeed novel, useful, and non-obvious to be patentable. Please examine the application carefully and grant it as a formal patent for protecting the rights of the inventor.

What is claimed is:

1. A heatable wear device, comprising:
a wear body;
at least one heating module installed inside the wear body, wherein the at least one heating module comprises:
an explosion-proof battery;
a heating layer electrically connected to the explosion-proof battery and disposed corresponding to the explosion-proof battery; and
a covering layer with a high specific heat clamped between the explosion-proof battery and the heating layer, wherein the covering layer with the high specific heat comprises a first surface and a second surface opposite to the first surface, wherein the first surface is attached to the explosion-proof battery and the second surface is attached to the heating layer; and
a circuit board installed inside the wear body and electrically connected to the explosion-proof battery.

2. The heatable wear device according to claim 1, wherein the explosion-proof battery is an FPC Lithium-Ceramic Battery, wherein the heating layer is woven from meal wires made of iron, steel, or copper, wherein the covering layer with the high specific heat is made of ceramic yarn or nylon yarn.

3. The heatable wear device according to claim 2, wherein the wear body has a lining to which the heating layer is attached.

4. The heatable wear device according to claim 3, wherein a controller is installed on the circuit board, wherein the controller controls electrical conduction and electrical insulation between the explosion-proof battery and the heating layer through the circuit board.

5. The heatable wear device according to claim 4, wherein the wear body is a glove comprising five finger portions and a wrist portion, wherein the number of the at least one heating module is five, each installed inside the respective finger portions, wherein the circuit board is installed inside the wrist portion, wherein the lining is formed on the inner surfaces of the respective finger portions.

6. The heatable wear device according to claim 4, wherein the wear body is a sock comprising a sole portion, an instep portion, and an ankle portion, wherein the at least one heating module is plural in number, wherein some of the heating modules are installed inside the sole portion and the others are installed inside the instep portion, wherein the circuit board is installed inside the ankle portion, wherein the lining is formed on the inner surfaces of the sole portion and the instep portion.

7. The heatable wear device according to claim 4, wherein the wear body is a vest, wherein the at least one heating module and the circuit board are installed inside the vest, wherein the lining is formed on the inner surface of the vest.

8. The heatable wear device according to claim 4, wherein the wear body is a scarf, wherein the at least one heating module and the circuit board are installed inside the scarf, wherein the lining is formed on the inner surface of the scarf

9. The heatable wear device according to claim 1, further comprising a USB connector installed on the circuit board, wherein the USB connector has a USB female connector.

10. The heatable wear device according to claim 9, wherein the USB connector further comprises an extension cord, wherein a terminal end of the extension cord is connected to the USB female connector.

11. The heatable wear device according to claim 1, further comprising a USB connector and a fixed case, wherein the USB connector is installed on the circuit board, wherein the USB connector has a USB female connector, wherein the fixed case is installed inside the wear body, wherein the at least one heating module is single in number, wherein the heating module is attached to one side of the fixed case, wherein the circuit board is received inside the fixed case which is provided with an opening exposing the USB female connector.

12. The heatable wear device according to claim 11, wherein the USB connector further comprises an extension cord, wherein part of the extension cord is exposed out of the opening of the USB female connector, wherein a terminal end of the extension cord is connected to the USB female connector.
